(19) United States
(12) Patent Application Publication
(10) Pub. No.: US 2009/0144159 A1
(43) Pub. Date: Jun. 4, 2009

(54) Advertisement Insertion Module and Advertisement Replacement Module

(76) Inventor: Suresh Bashyam, Sunnyvale, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/328,679

(22) Filed: Dec. 4, 2008

Related U.S. Application Data
(60) Provisional application No. 60/992,234, filed on Dec. 4, 2007.

(51) Int. Cl. G06Q 30/00; H04M 3/42

(52) U.S. Cl. 705/14; 455/414.2

(57) ABSTRACT

A computer-implemented method including receiving request data originating at a mobile device; obtaining a unique and unchanging identifier of the mobile device based on the received request data; associating the unique and unchanging identifier of the mobile device with the request data; and storing the associated data at a data storage device.

### CROSS REFERENCE TO RELATED PATENTS

This application claims the benefit of U.S. Provisional Application No. 60/992,234, filed Dec. 4, 2007, titled “Advertisement Insertion Module and Advertisement Replacement Module,” which is incorporated herein by reference.

### BACKGROUND INFORMATION

Mobile marketing offers the most direct and personal way of getting in touch with a consumer. For awareness, sales promotion, or customer retention, mobile marketing adds an interactive dimension that is unparalleled for effectiveness and immediacy. For years now, reaching attractive and relevant target groups via classical media such as printed media and TV has been getting ever more difficult. This is exactly where the mobile phone comes in as a marketing channel. In many countries, mobile phones already outnumber TV sets, and the typical user behavior (always on, anytime, anywhere) makes mobile phones the first interactive mass medium. Mobile marketing is already becoming an integral part of a brand's overall marketing mix, and with very high success rates.

### BRIEF DESCRIPTION OF THE DRAWINGS

FIG. 1 is a block diagram of an exemplary system.

FIG. 2 is a block diagram illustrating an embodiment of the exemplary system of FIG. 1.

FIG. 3 is a functional diagram illustrating an exemplary communication flow for associating a mobile device with requested content in the exemplary system of FIG. 2.

FIG. 4A is a flowchart representing an exemplary method for associating a mobile device with requested content.

FIG. 4B is a flowchart representing an exemplary method for associating an identifier of the mobile device with unlimited requested content.

FIG. 5 is a functional diagram illustrating an exemplary communication flow for providing advertisements in the exemplary system of FIG. 2.

FIG. 6 is a functional diagram illustrating another exemplary communication flow for providing advertisements in the exemplary system of FIG. 2.

FIG. 7 illustrates an exemplary mobile advertisement placement off the web content.

FIG. 8 is a flowchart representing an exemplary method for processing request data.

FIG. 9 is a flowchart representing an exemplary method for processing mobile advertisement insertion.

FIG. 10 is a flowchart representing an exemplary method for mobile advertisement replacement.

### DESCRIPTION OF THE EMBODIMENTS

Reference will now be made in detail to the exemplary embodiments implemented according to the Advertisement Insertion Module and Advertisement Replacement Module, the examples of which are illustrated in the accompanying drawings. Wherever possible, the same reference numbers will be used throughout the drawings to refer to the same or like parts.

To take full advantage of mobile marketing, the following description provides a unique way for carriers to promote their own products or third party products via mobile marketing campaigns. Further, a proxy server described herein can be placed at the edge of the mobile network and can act as a gateway to the internet for all mobile traffic. As a result, the proxy server can obtain information regarding the subscriber, the content that is currently served to that subscriber, and the history about the subscriber. The systems disclosed herein provides a powerful value proposition for the carrier and for the marketing team. In some embodiments, the proxy server and system can be supported by Bytemobile's Web Fidelity™ Service (WFS).

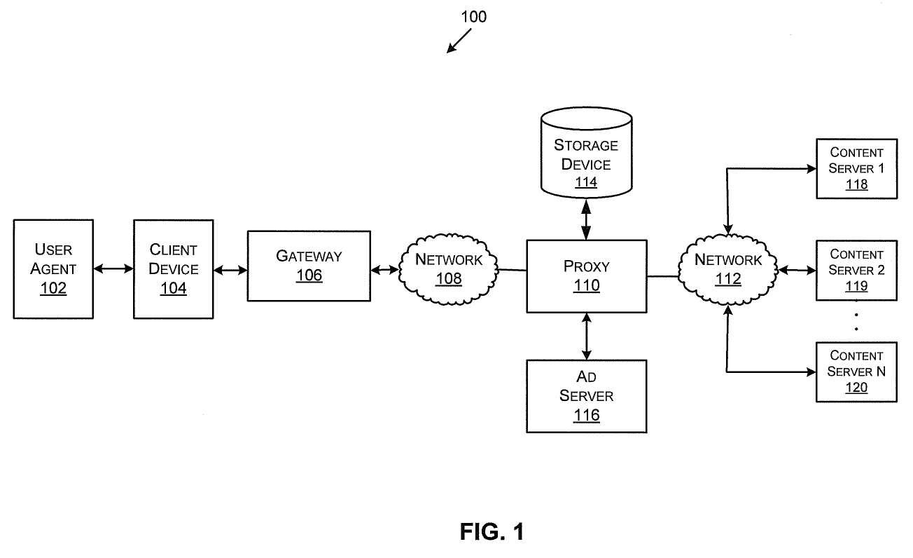

FIG. 1 is a block diagram of an exemplary system. Exemplary system 100 can be any type of system that transmits data over a network, such as a wireless network, Internet, etc. For example, the exemplary system can include a browser requesting access to content from content servers through the Internet. The exemplary system can include, among other things, a user agent 102, a client device 104, a gateway 106, one or more networks 108, 112, a proxy 110, a storage device 114, an advertisement (ad) server 116, and one or more content servers 118-120.

User agent 102 is a client application used with a network protocol. For example, user agent 102 could be a web browser, a search engine crawler, a screen reader, or a Braille browser, and user agent 102 could be used to access the Internet. User agent 102 can be a software program that transmits request data (e.g., an HTTP/HTTPS/WAP/WAIS/Gopher/RTSP request, etc.) to a web server and receives response data in response to the request data. For example, user agent 102 can send request data to content servers 118-120 for a particular file or object data of a web page by its URL, and the content server of the web page can query the object data in a database and can send back the object data as part of the response data (e.g., HTTP/WAP response data) to the user agent. This process can continue until every object in the web page has been downloaded to the user agent.

Client device 104 is a computer program or hardware device that can access remote services. Client device 104 can receive request data from user agent 102, can transmit the request data to the content servers, and can receive response data in response to the request data. For example, client device 104 can be Bytemobile Optimization Client Software. In some embodiments, user agent 102 and client device 104 can be housed in the same device, such as a computer, a PDA, a cell phone, a laptop, or any device accessing the Internet. In some embodiments, client device 104 can be removed and its functionality can be included in user agent 102.

Gateway 106 is one or more devices that convert formatted data provided in one type of network to a particular format required for another type of network. Gateway 106, for example, may be a server, a router, a firewall server, a host, or a proxy server. Gateway 106 has the ability to transform the signals received from client device 104 into signals that network 108 can understand and vice versa. Gateway 106 may be capable of processing audio, video, and T.120 transmissions alone or in any combination, and is capable of full duplex media translations.

The one or more devices of gateway 106 can also include a Bytemobile Unison Gateway. Gateway 106 receives a data call request from a mobile device (user agent 102 and client device 104 utilizing user agent 102), along with information such as a unique and unchanging identifier of the mobile device and Password Authentication Protocol (PAP) or Challenge Handshake Authentication Protocol (CHAP) authentication credentials of the mobile device. Gateway 106 sends the authentication credentials to a Remote Authentication Dial In User Service (RADIUS) server, which can authenticate the mobile device. After the authentication, gateway 106 assigns an IP address to the mobile device, and associates/stores the assigned IP address with the unique unchanging identifier of the mobile device, such as a telephone number or a network access identifier (NAI).

Networks 108 and 112 can be any type of network, including, but not limited to, any combination of wide area networks (WANs), local area networks (LANs), or wireless networks suitable for networking communication such as Internet communication.

Proxy 110 is a server that provides communication between gateway 106, content servers 118-120, and ad server 116. For example, proxy 110 could include Bytemobile's Unison Mobile Internet Platform and Bytemobile's Web Fidelity Service. Proxy 110 can configure response content data, include ad data off the response content data, and provide the response content data and the ad data to a device utilizing user agent 102. In some embodiments, proxy 110 can include an ad insertion module, which is further described below.

Storage device 114 is one or more devices that stores the information of the devices utilizing the user agent 102 and the information of the device's subscribed users. Storage device can store profiling data of the user of the device utilizing user agent 102. Further, storage device 114 can store ad parameters, which can include, among other things, the specifications of user agent 102 and the device utilizing user agent 102. For example, the ad parameters can include, among other things, the type of user agent, the type/properties of the mobile device, Mobile Systems International Subscriber Identity Number (MSISDN; also known as the telephone number of a mobile device), an access point (APN), an identifier for an ad campaign (Ad Plan-ID), Bearer/SGSN-IP, configurable RADIUS attributes (such as mobile service plan, call region, etc.), the time (year, month, day), an operator ID, a device ID, a source IP, a LAN interface ID, a URL address of web content, and an estimated location of the user.

In some embodiments, storage device 114 can be located within proxy 110, local to proxy 110, or remote from proxy 110. The stored information of the devices and users can assist proxy 110 in, among other things, determining whether to include ads off the content of the response data, whether to include ads within the content, the type/format of ads to provide, and which ad campaign to select. Storage device 114 can be any type of device that stores data.

Ad server 116 is a server that stores ad campaign data and provides an ad campaign based on the information of a mobile device and its subscribed user. It can be a software program and/or hardware device. In some embodiments, ad server 116 can be located within proxy 110, local to proxy 110, or remote from proxy 110.

Content servers 118-120 are servers that receive the request data from user agent 102, process the request data accordingly, and return the response data back to user agent 102. For example, content servers 118-120 can be a web server, an enterprise server, or any other type of server. Content servers 118-120 can be a computer or a computer program responsible for accepting HTTP requests from the user agent and serving the user agents with web pages.

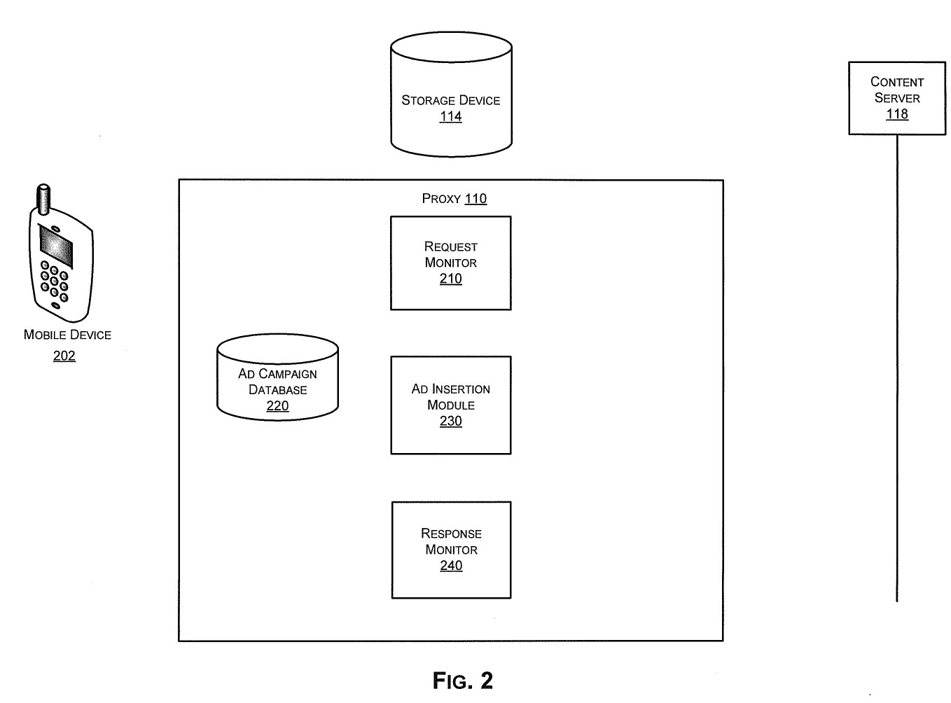

FIG. 2 is a block diagram illustrating an embodiment of the exemplary system of FIG. 1. Gateway 106 is omitted from FIG. 2 for simplicity. Mobile device 202 is a wireless device that can include, among other things, user agent 102 and/or client device 104. While it is preferred that mobile device 202 can be a mobile phone, it will be appreciated by one of ordinary skill in the art that mobile device 202 can be any type of mobile device having a unique and unchanging identifier assigned to it, wherein this unique and unchanging identifier is communicated along with a request for web content.

Proxy 110 may include, among other things, a request monitor 210, an ad campaign database 220, an ad insertion module 230, and a response monitor 240. As stated above, in some embodiments, storage device 114 can be located within, local to, or remote from proxy 110.

Request monitor 210 can be a software program and/or a hardware device that receives or intercepts the request data, such as an HTTP request for a specific URL, from mobile device 202. Request monitor 210 has the ability to extract device information from the request data and to provide the device information to the storage device 114 in exchange for ad parameters, which can be provided to ad insertion module 230 for future processing. These ad parameters can include data describing the types and properties of the user agent and mobile device, such as screen size, etc.

Request monitor 210 can also extract the IP address of the mobile device from the request data and use it to obtain a unique and unchanging identifier, such as a telephone number or NAI, associated with mobile device 202. Request monitor 210 can associate the unique and unchanging identifier with the request data for providing to storage device 114, which stores user profiling data. Further, request monitor 210 can transmit the request data to content server 116.

Ad campaign database 220 can be a structured collection of records or data of mobile ad campaigns. The structure can be organized as a relational database or an object-oriented database. A computer software, such as a database management system, is utilized to manage and provide access to ad campaign database 220. In some embodiments, ad campaign database 220 can include an ad landing page for an ad. In some embodiments, ad campaign database 220 can be located within, local to, or remote from proxy 110.

Ad insertion module 230 can be a software program and/or a hardware device that receives the response data from response monitor 240, and obtains an ad campaign based on the ad parameters of mobile device 202. In some embodiments, the ad campaign can be selected based at least in part on the subscribed user. While ad insertion module 230 is illustrated as being within proxy 110, one of ordinary skill in the art will appreciate that ad insertion module 230 can be local to or remote from proxy 110. In some embodiments, ad insertion module 230 can provide an ad campaign off the response content data (“off content ad”). If the response data is provided to it, ad insertion module 230 can provide the response data with the off content ad to response monitor 240. In some embodiments, ad insertion module 230 can simply provide request monitor 240 with the off content ad for request monitor 240 to include the ad when sending the response data. In some embodiments, ad insertion module 230 can replace ads in the response data with a carefully selected ad campaign, which can be curtailed to fit based on the parameters of mobile device 202.

Further, the ad campaigns can be selected based on user profiling data of subscribed users stored at storage device 114 in order to better meet the needs of the user. The ad campaign typically includes a set of ads so chosen to achieve a particular marketing goal. For example, a car dealer may have a sales promotion campaign consisting of selective images or video streams of cars for sale. The Mobile Marketing Association has set standards on the image/video frame sizes for such marketing campaigns. Ad insertion module 230 can selectively pick a subset of such images or video streams based on the information of mobile device 202 and its subscribed user, e.g., pre-configured criteria, such as the configuration of mobile device 202, user demographic, user behavior, likely location of the user, web sites visited, etc.

Each ad campaign can have multiple ads. Each campaign can be configured, among other things, with the following criteria: frequency of ad display, timing, domains, and RADIUS attributes (subscriber group). Typically the carrier can begin by first creating an ad. Each ad can have, among other things, the following attributes: an ad image or an ad video stream, and a link for the ad image/video stream.

After the carrier has configured the ads in the system, it groups these ads into a campaign. A campaign definition can have, among other things, the following attributes: list of one or many ads, campaign dates, weight, enable/disable, and ad selection (random or round robin).

Typically operators and the brand owners can control the campaign execution based on the following criteria:
Frequency—refers to the average number of times that a campaign consumer is exposed to the subscribers. A company usually establishes goals, which can vary for each advertising campaign. In terms of mobile ads the key measure is number of impressions. An impression is an exposure of an ad in a campaign.
Timing—refers to the precise timing of the advertising campaign. For example, some companies run ads during the holidays to promote season-specific products. Or, for example, a brand owner may employ either a continuous or pulsing pattern of ads. Continuous refers to campaigns that are run on a scheduled basis for a given time period. Pulsing refers to campaigns that are run with high intensity for a short period of time.
Domain Targeting—refers to controlling whether to display an ad based on the web site domain. This is very useful in cases where the Brand owners want to target users going to a particular websites or where they do not want to target users going to a particular website.
Subscriber/Subscriber Group Targeting—refers to targeting based on subscriber groups. Such groupings are typically based on specific demographics but could extend beyond demographics, for example, to targeting pre-paid or post paid users, behavioral targeting, interest-based targeting, and etc.

Typically brand owners and operators will be interested in measuring the Ad-Impact, using campaign reporting and feedback. Ad-impact refers to measuring the effectiveness of the advertising campaign. This is typically measured in terms of number of “click-throughs” for a given ad and across the entire campaign. To measure the ad-impact, the ad system in general records the number of times a particular campaign was displayed, which ad in the campaign was displayed, and how many such ads were clicked.

Referring back to FIG. 2, response monitor 240 can be a software program or a hardware device that receives response data from content server 118. After receiving the response data, in some embodiments, response monitor 240 provides the content data to ad insertion module 230. Upon receiving data including both the response data and the ad data from ad insertion module 230, response monitor 240 can transmit to mobile device 202 the requested content data and any ad data received ad insertion module 230. In some embodiments, response monitor 240 can simply receive the ad data from ad insertion module 230 and include the ad content with the response data when sending to mobile device 202.

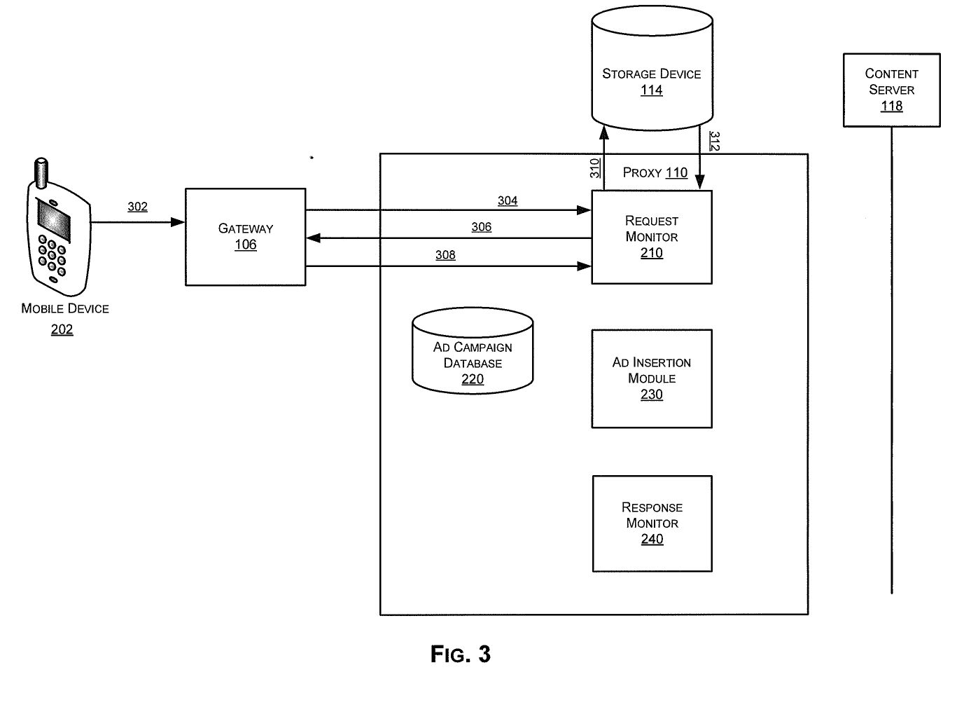

FIG. 3 is a functional diagram illustrating an exemplary communication flow for associating a mobile device with requested content in the exemplary system of FIG. 2. After receiving a request for web content from a user, mobile device 202 sends (302) a request to gateway 106. The request to gateway 106 would include, among other things, information such as a unique and unchanging identifier of mobile device 202 (e.g., a telephone number or a NAI), and PAP/CHAP authentication credentials of mobile device 202. In some embodiments, the request data can include, among other things, the type of user agent on mobile device 202 and the type of mobile device 202.

As is well known in the art, gateway 106, upon receiving the request, then forwards the authentication credentials of mobile device 202 to a RADIUS server. The RADIUS server authenticates mobile device 202 using the authentication credentials. Once receiving an “ok” signal from the RADIUS server, gateway 106 assigns an IP address dynamically to mobile device 202. Gateway 106 stores a record including the association between the assigned IP address of mobile device 202 and the unique and unchanging identifier of mobile device 202. If mobile device 202 drops the request, gateway 106 will be informed that the assigned IP address is no longer active. And gateway 106 can remove the record from storage.

After the authentication, gateway 106 forwards (304) the request data to proxy 110. The request data can include the requested web content and the assigned IP address. The request data can be directed explicitly to proxy 110, or it can be directed to content server 118 and the request can be intercepted transparently by an inline proxy or gateway.

Upon receiving the request data from gateway 106, request monitor 210 extracts the assigned IP address of mobile device 202 from the request data, and uses the IP address to obtain the unique and unchanging identifier of mobile device 202. Request monitor 210 then examines the request to obtain user profiling data according to the user's interactions with mobile device 202. This user profiling data can include, among other things, the requested URL, the date and time of the request, the user's approximate location, the type of user agent, and the type of mobile device.

To effectively store this user profiling data, proxy 110, alone or in combination with storage device 114, would need to associate this user profiling data with an identifier of mobile device 202. As indicated above, the request includes an IP address assigned by gateway 106. An exemplary problem with using this assigned IP address as the identifier associated with the user profiling data is that this assigned IP address would change when mobile device 202 makes a request at different time, switches from one network to another network, or registers with a network at a different time. So using an assigned IP address as the identifier associated with the user profiling data would be counter productive because several different entries would likely exist for a single mobile device, or several different users could be associated with a single IP address entry, both of which would result in inaccurate user profile data.

To overcome these inaccuracies, proxy 110 could obtain the unique and unchanging identifier, such as the telephone number or a NAI, associated with the mobile device. Telephone numbers and NAIs are unique to each phone and, except for a few circumstances, do not change. In some embodiment, to obtain the unique and unchanging identifier, request monitor 210 can send (306) the assigned IP address to gateway 106 in exchange for the unique and unchanging identifier. Gateway 106, having the association between the assigned IP address and the unique and unchanging identifier, sends (308) the unique and unchanging identifier to proxy 110. In some embodiments, gateway 106 can forward (304) the request data and the unique and unchanging identifier together to request monitor 210, so communications 306 and 308 can be skipped, and request monitor 210 can acquire the unique and unchanging identifier by extracting it from the request data.

Proxy 110 can monitor a user's behavior or interactions of mobile device 202 in the request data. In some embodiments, request monitor 210 associates the unique and unchanging identifier of mobile device 202 with the request data, e.g., a domain name, a URL, and/or a subject matter with the request data. It stores (310) the unique and unchanging identifier and the associated request data in storage device 114 for updating the user's profiling data. At some point, storage device 114 can provide (312) this user profiling data to proxy 110. This user profiling data can be used for a wide variety of things, such as providing more effective advertisements to the user of the mobile device.

By having the ability to monitor all data requested (“unlimited monitoring”) by mobile device 202, the user profiling data stored at storage device 114 is not limited to a user's interactions with a specific website (“unlimited web content”). Unlimited monitoring a user's behavior is different from the limited monitoring used by Google and Yahoo! advertising services. The limited monitoring and association used by Google and Yahoo! advertising services is limited because they require a user to interact with their websites, i.e., limited web content, in order to obtain user profiling data. Google and Yahoo! advertising services may track/monitor a user's browsing behavior/interactions with a Google/Yahoo! website or a website embedding Google/Yahoo! search engines, and provide ads based on the interactions. For example, the services can provide corresponding ads based on search keywords provided to Google/Yahoo! search engines by the user. But if the user visits a non-Google/non-Yahoo! website without Google/Yahoo! search engines embedded, the services are not able to monitor the interaction, and thus cannot provide corresponding ads. Google and Yahoo! advertising services may associate the user's web-browsing behavior with the user account when the user logs into and interacts with an authenticating Google/Yahoo! website, for example, Gmail or Yahoo! Mail. But if the user does not log into and interact with the authenticating Google/Yahoo! website, the services are not able to associate the user's web-browsing behavior with the user account. Thus, the limited monitoring and association utilized by Google and Yahoo! advertising services is limited to Google/Yahoo! authenticating websites or websites embedding Google/Yahoo! search engines.

In contrast, the embodiments described above in FIG. 3 utilize an unlimiting monitoring and association, which applies to all web contents, i.e., unlimited web content. Without requiring the use of HTTP cookies, proxy 110 can monitor the subscribed user's behavior or interactions for any request that the mobile device makes. And it can associate the user's behavior or interactions in any request with the unique and unchanging identifier of the mobile device and its subscribed user. For example, proxy 110 can monitor all web contents the mobile device requests, no matter whether these web contents belong to any particular domains (e.g., a Google/Yahoo! website or a non-Google/non-Yahoo! website), or require authentication or not. Proxy 110 can then associate and store all user browsing behavior with the unique and unchanging identifier of mobile device 202. Later, proxy 110 can provide a carefully selected ad campaign to mobile device 202 based on the user's behavior information, to meet the user's particular needs. Thus, the unlimited monitoring and association has apparent advantages over those used by other advertising services.

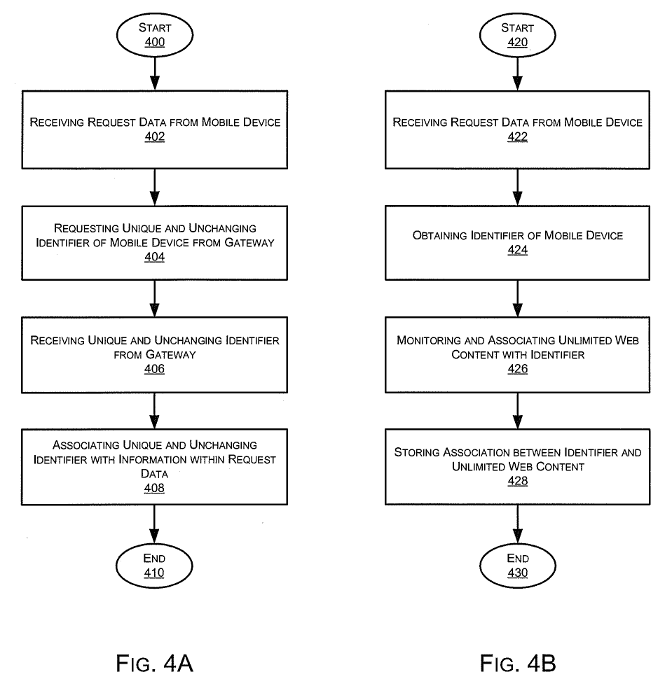

FIG. 4A is a flowchart representing an exemplary method for associating a mobile device with requested content. It will be readily appreciated by one of ordinary skill in the art that the illustrated procedure can be altered to delete steps or further include additional steps. After initial start step 400, a proxy receives (402) request data from a mobile device, via a gateway. After authenticating the mobile device by a RADIUS server, the gateway assigns and inserts into the request data, an IP address associated with the mobile device. While the proxy can track user behavior data based on an IP address associated with the mobile device, the problem with tracking based on an IP address is that the IP address of the mobile device changes as the mobile device moves from network to network or as the mobile device re-registers within the same network.

An exemplary way to track user behavior is using a unique and unchanging identifier associated with the mobile device. An example of a unique and unchanging identifier includes a telephone number or a NAI of the mobile device. While the unique and unchanging identifier can be a MAC address, the MAC address is more difficult to obtain because the gateway would further need to request the MAC address of the mobile device from another component within the network—as opposed to using the telephone number or NAI of the mobile device, which has already been stored at the gateway or the proxy.

After receiving (402) the request data, the proxy can acquire a unique and unchanging identifier of the mobile device by requesting (404) the identifier from the gateway, which has a correlation between the IP address and the unique and unchanging identifier. For example, the proxy could send the IP address of the mobile device in exchange for the unique and unchanging identifier. At some point thereafter, the proxy receives (406) the unique and unchanging identifier from the gateway.

In some embodiments, the gateway forwards the request data and the unique and unchanging identifier of the mobile device together to the proxy. Thus, the proxy can skip steps 404 and 406 and acquire the unique and unchanging identifier by extracting it from the request data.

After receiving the identifier, the proxy associates (408) the identifier with information within the request data, and then proceeds to end (410). As stated above, the unlimited association 408 described here is more effective than other limited monitoring and association models, such as the limited monitoring and association provided by the Google or Yahoo! model described above. Here, without requiring the use of HTTP cookies, the proxy can monitor all web content requested by the mobile device, and associate the unique and unchanging identifier of the mobile device with all of these web contents.

FIG. 4B is a flowchart representing an exemplary method for associating an identifier of the mobile device with unlimited web content. It will be readily appreciated by one of ordinary skill in the art that the illustrated procedure can be altered to delete steps or further include additional steps. After initial start step 420, a proxy receives (422) request data from a mobile device. In some embodiments, the proxy may receive the request data from the mobile device, via a gateway. This request data can include, among other things, an identifier associated with the mobile device and unlimited content data. As indicated above, this unlimited content data includes all content data and is not limited to web content that requires a user interacting with a specific website.

After receiving the request data, the proxy can obtain (424) an identifier of the mobile device. This identifier could be an IP address, a unique and unchanging identifier as described above in FIG. 4A, or any other type of identifier. After obtaining the identifier, the proxy monitors and associates (426) the unlimited request content data with the identifier. Then, the proxy can store (428) the association between the unlimited request content data and the identifier associated with the mobile device.

As stated above, the unlimited monitoring and association 408 described here is more effective than the limited monitoring and association models, such as the limited monitoring and association provided by the Google or Yahoo! model. Here, without requiring the use of HTTP cookies, the proxy can monitor all web content thereby allowing the storage of more accurate user profiling data for providing a more effective ad campaign.

In addition, the proxy can also store additional request data, such as the requested URL, the date and time of the request, the user's approximate location, the type of user agent, and the type of mobile device. This stored associated data can be used to add a new user profile or update an existing user profiling data. After storing the association, the method can end (430).

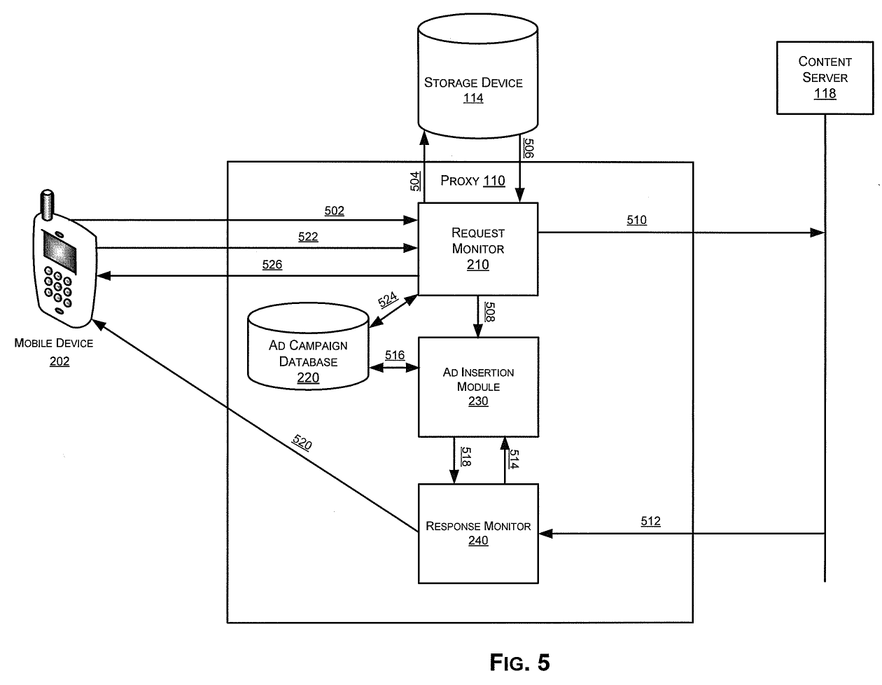

FIG. 5 is a functional diagram illustrating an exemplary communication flow for providing advertisements in the exemplary system of FIG. 2. It is assumed for the purposes of explaining this exemplary communication flow that the request data corresponds to a request for a URL.

The user inputs a URL into a user agent of the mobile device 202. Mobile device 202 then transmits (502) the request data to proxy 110. The request data can include, among other things, the requested URL and device information data identifying the mobile device and the type of user agent on the mobile device. The request data can be directed explicitly to proxy 110 or to a gateway and then to proxy 110, or it can be directed to content server 118 and the request can be intercepted transparently by an inline proxy or gateway.

Request monitor 210 extracts the device information data from the request data and then transmits (504) the device information data to storage device 114. Responsive to the device information data, storage device 114 returns (506) ad parameters of mobile device 202. These ad parameters can include, among other things, the specifications of user agent 102 and of mobile device 202. For example, the ad parameters can include, among other things, the type of user agent, the type/properties of a mobile device, a Mobile Systems International Subscriber Identity Number (MSISDN; also known as the telephone number of a mobile device), an access point (APN), an identifier for an ad campaign (Ad Plan-ID), a Bearer/SGSN-IP, configurable RADIUS attributes (such as mobile service plan, call region, etc.), the time (year, month, day), an operator ID, a device ID, a source IP, a LAN interface ID, a URL address of web content, and an estimated location of the user. Moreover, in some embodiments, request monitor 210 can acquire a unique and unchanging identifier of mobile device 202, as described above, in order to obtain user profiling data, from storage device 114, for providing a more effect ad campaign.

Upon receiving the ad parameters of mobile device 202 and/or user profiling information, request monitor 210 can forward (508) the ad parameters and/or user profiling information to ad insertion module 230 for future referencing. In some embodiments, ad insertion module 230 receives the unique and unchanging identifier of mobile device 202 from request monitor 210 and stores it. Later, ad insertion module 230 can retrieve the ad parameters of mobile device 202 and/or user profiling information from storage device 114, based on the identifier.

After communicating with ad insertion module 230, request monitor 210 forwards (510) the request data to content server 118. In some embodiments, request monitor 210 forwards (510) the request data to content server 118 before communicating (508) with ad insertion module 230. Subsequently, content server 118 provides (512) response data (e.g., HTTP response), associated with the request data, to response monitor 240 of proxy 110. The response data can include, among other things, an HTML document, a Cascaded Style Sheet Files, images, and one or more JavaScript files, all of which constitute the requested webpage.

Upon receiving the response data, if allowed to place ads off the content of the response data, response monitor 240 forwards (514) the response data to ad insertion module 230. In some embodiments, instead of sending the response data, response monitor 240 can communicate with ad insertion module 230 to receive an ad campaign. Based on the received ad parameters and/or user profiling data, ad insertion module 230 selects and retrieves (516) from ad campaign database 220 an ad campaign. The selected ad campaign is the one curtailed to meet the needs of the user and/or to fit in the specification of mobile device 202. The ad campaign selection process will be discussed in further details below. According to an ad insertion configuration set by operators, ad insertion module 230 provides the ad campaign off the web content (“off content ad”), such as on the header, footer, or both.

After receiving an ad campaign, ad insertion module 230 sends (518) the response data with the off content ad to response monitor 240, which in turn forwards (520) to mobile device 202. Further, in some embodiments, ad insertion module 230 can provide the off content ad to response monitor 240, which then sends the response data and off content ad to mobile device 202.

The user can then view the content of the response data and the ad campaign at mobile device 202. The ad campaign links to an ad landing page, which is the page that displays when the user clicks on the ad campaign. The page usually displays content that is a logical extension of the ad campaign. When the user clicks on the ad campaign, mobile device 202 sends (522) the request for the ad landing page to proxy 110. In some embodiments, request monitor 210 identifies and retrieves (524) the ad landing page from ad campaign database 220, and returns (526) the ad landing page to mobile device 202. The user can then view the landing page at mobile device 202.

Further, in some embodiments, the landing page is hosted by a third party, and request monitor forwards the request of the ad landing page to content server 118. Content server 118 in turn provides the ad landing page to response monitor 240, which in turn forwards the page to mobile device 202. In yet another embodiment, request monitor 210 can request and receive the page from the third party, e.g., content server 118, and directly forward the page to mobile device 202.

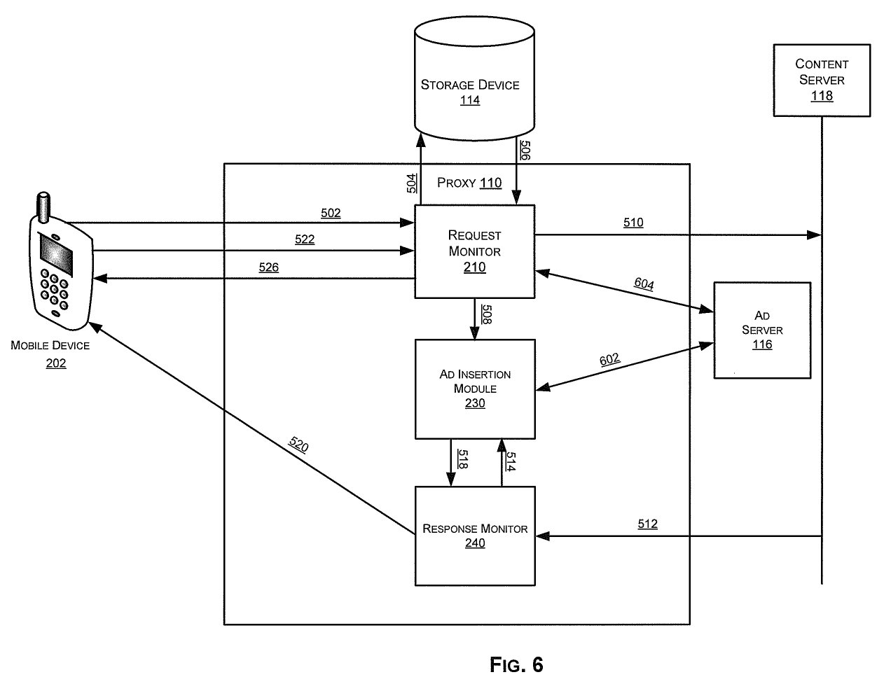

FIG. 6 is a functional diagram illustrating another exemplary communication flow in the exemplary system of FIG. 2. The system in FIG. 6 has similar components to those in FIG. 5, except that in FIG. 6, proxy 110 does not have an ad campaign database, and a third party ad server 116 stores and provides the ad campaign data. Ad insertion module 230 and/or request monitor 210 interacts with ad server 116 to the obtain ad campaign data.

When receiving a (602) request for an ad campaign from ad insertion module 230, ad server 116 provides (602) the requested ad campaign based on the ad parameters and/or user profiling data. The requested ad campaign is the one curtailed to meet the needs of the user and/or to fit in the specification of mobile device 202.

When receiving (604) a request for an ad landing page from request monitor 210, ad server 116 identifies the requested ad landing page, and returns (604) the ad landing page to request monitor 210.

The rest of communication flow is similar to the communication flow provided above in FIG. 5.

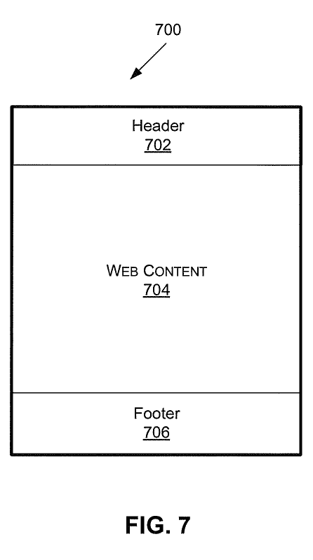

FIG. 7 illustrates a mobile ad placement off the web content. Operators can set an ad insertion configuration, which can be maintained on proxy 110, to globally configure whether to provide off content ads with the web content or on any sub-pages of the web content. Moreover, the operators can also globally configure where to place the off content ads with each webpage. For a displayed webpage, web content 704 is the response data received from content server 118, as described above. The off content ads are placed outside of web content 704, i.e., being placed off the web content 704. In some embodiments, the off content ads can be placed on a header 702. Further, in some embodiments, the off content ads can be placed on a footer 706. In yet another embodiment, the off content ads can be placed on both header 702 and footer 706.

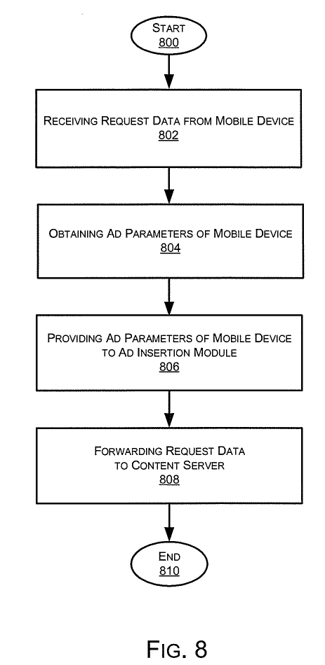

FIG. 8 is a flowchart representing an exemplary method for processing request data. It will be readily appreciated by one of ordinary skill in the art that the illustrated procedure can be altered to delete steps or further include additional steps. After initial start step 800, a proxy receives (802) request data from a mobile device. In some embodiments, the request data can include, among other things, a requested URL and device information data. The device information data can include, among other things, the type of mobile device and the type of user agent at the mobile device. In some embodiments, the request data may also include a device identifier.

Upon receiving (802) the request-data, the proxy obtains (804) ad parameters by providing the device information data of the mobile device. In some embodiments, the proxy can also obtain user profiling data for providing more efficient ads to the mobile device. After receiving the ad parameters, the proxy can provide (806) the ad parameters to an ad insertion module for future processing.

The proxy can then forward (808) the request data to a content server where the content server transmits response data to the proxy; the response data including content data corresponding to the request. In some embodiments, the proxy can add additional parameters to the request data to ensure that the content server will reply with a webpage. In some embodiments, forwarding step 808 can occur at some point prior to providing step 806. After the forwarding, the method can end (810).

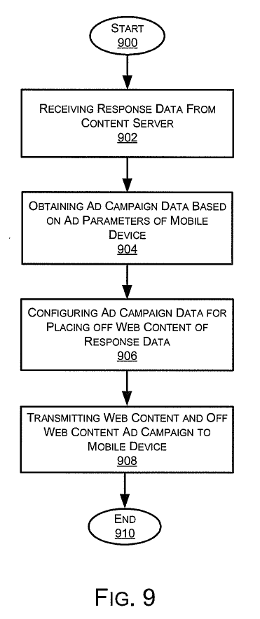

FIG. 9 is a flowchart representing an exemplary method for processing mobile ad Insertion. It will be readily appreciated by one of ordinary skill in the art that the illustrated procedure can be altered to delete steps or further include additional steps. After initial start step 900, a proxy receives (902) response data from a content server. This response data can include web content that was requested by a user from a mobile device.

After receiving the response data, the proxy obtains (904) ad campaign data according to ad parameters of the mobile device derived from the original request for the web content. In some embodiments, the ad parameters can include user profiling data. The proxy uses the ad parameters of the mobile device to help select an ad campaign, which is curtailed to meet the needs of the user and/or to fit in the specification of the mobile device and the user agent, as described above. For example, a particular ad campaign can be selected based, among other things, on the mobile device, the domain (can be an exclude or include list), the time of the day, the RADIUS attributes (for subscriber groups), the subscriber behavioral characteristics, the subscriber interests, and/or the location of subscriber. For example, if the ad parameters of the mobile device and user profiling data indicate that the user is interested in buying a car and the device supports video streams, then the proxy would select a video ad campaign of cars. If the device does not support video stream, the proxy would select a still image ad campaign. Also, the frame size of the selected video and/or still image ad campaign must fit in the screen dimension of the mobile device.

For another example, the stored information of the subscribed user indicates that the user works from 8:00 am to 3:00 pm of every weekday, and stays at home during the remaining time. Based on this information, if the mobile sends a request during 8:00 am to 3:00 pm on any weekday, the proxy can select an ad campaign related to the user's work and/or work location, but will select an ad campaign related to the user's home hobbies if request is made during outside of this time frame.

For yet another example, the stored information of the mobile device indicates that during the last several hours (or particular days, or particular time of particular days), the mobile device made requests from a particular location. Based on this information, if the mobile devices makes a request again during the similar time period, the proxy can select an ad campaign related to that location, for example, shopping, dining, or entertaining information near that location.

For still another example, the stored user profiling data of the subscribed user indicates that the user likes to spend his time in a bar on Wednesday night. Based on this behavioral characteristics, the proxy will select an ad campaign suitable to this particular hobby of the user on Wednesday night.

When fetching an ad, the proxy can determine which campaign can meet the criteria for the given device and its subscribed user. This might result in one or multiple campaigns being eligible for display. If there is only one campaign then this campaign can be chosen. Within that campaign, the ads can be selected based on the ad selection algorithm pre-set for that campaign. If multiple campaigns get selected for a particular request then, in some embodiments, weights associated with the campaign can be used, as illustrated as following:

Total Weights=sum of all weights

Probability of each campaign=weight of the campaign/total weight

For example C1=3, C2=5, C3=2. Total weight=10

C1 probability= 3/10=30%

C2 probability= 5/10=50%

C3 probability= 2/10=20%

A campaign is then randomly chosen according to the probability weighting above. While the above illustrates an exemplary process of ad campaign selection, any selection process can be used.

The proxy can also provide a default ad campaign. When there is no other campaign or when no other campaign meets the criteria, the default ad campaign can be chosen. The default ad campaign may just be a carrier logo. In some embodiments, ad campaigns are stored on the proxy. Further, in some embodiments, ad campaigns are stored in a database local to the proxy. In yet another embodiment, ad campaigns are stored on a third party ad server.

Referring back to FIG. 9, after obtaining (904) the selected ad campaign data, the proxy can configure (906) the selected ad campaign for placing off the web content, i.e., on the header and/or footer of the web content, based on an ad insertion configuration, as described above.

The proxy then transmits (908) the web content and the off content ad campaign to the mobile device that originally made the request for the web content. After the transmission, the method can then end (910).

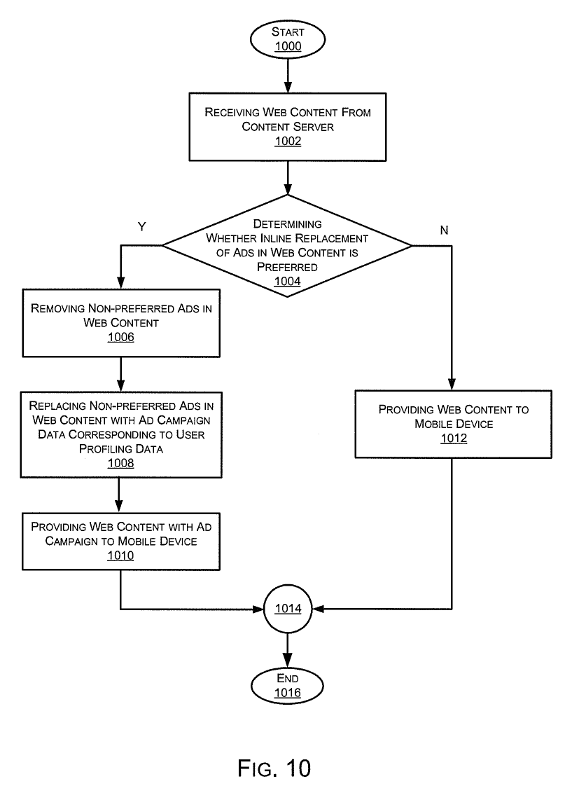

FIG. 10 is a flowchart representing an exemplary method for mobile ad replacement. It will be readily appreciated by one of ordinary skill in the art that the illustrated procedure can be altered to delete steps or further include additional steps. After initial start step 1000, a proxy receives (1002) response data, which includes web content, from a content server. This web content can correspond to a web content requested by a user.

Sometimes, the web content contains ads, which are provided to users who request access to the web content, no matter whether a particular user is interested in viewing the ads or not, and no matter whether the ads can fit in the specification of a requesting device. For example, the user likes to drink Pepsi, but dislikes Coke. The content server does not know this, and still provides the web content containing an ad promoting Coke. The user would not be interested in clicking on the Coke ad.

For another example, the mobile device cannot display a video stream, but the content server provides the web content containing a video ad promoting Pepsi. Although the user is likely to view and click the video ad, the mobile device would not be able to display the video ad. Thus, it is in the user's and the carrier's best interests to replace the ads with carefully selected ads, which are curtailed to meet the particular need of the user and/or to fit in the specification of a mobile device. In the best interests of the both the content provider and an advertiser, a prior permission from the web content provider/owner may be obtained before the replacement takes place. The permission can be a prior agreement, or a permission given/embedded in the response data.

In one scenario, the replacement can be an inline replacement—replacing the original ads in the web content with the curtailed ads provided by the ad insertion module—as if the curtailed ads were originally there. In yet another scenario, the original ads in the web content can be just an ad placeholder, which reserves a space for ads but no ads are placed yet. The ad insertion module can select a curtailed ad campaign and place it in the ad placeholder. This is also a variance of inline replacement. In still another scenario, the ads replacement can be non-inline replacement. The ad insertion module can remove or strip out the original ads, spaces and corresponding markup language tags (such as HTML tags or XML tags) from the web content, and place the curtailed ad campaign off the web content, as described above. The preference to inline-replacement or non-inline replacement can be pre-configured.

Referring back to FIG. 10, assuming the permission for ads replacement is given, after receiving the response data, the proxy determines (1004) whether inline-replacement of ads in the web content is preferred. If inline-replacement is preferred, the proxy removes (1006) the ads in the web content, and replaces (1008) the ads in the web content with an ad campaign selected based on the user profiling data, as described above.

After replacing the ads of the web content, the proxy provides (1010) the web content with replaced ads to the mobile device.

If the inline replacement of ads in web content is not preferred, the proxy can provide (1012) the web content, without the inline ads, to the mobile device. In some embodiments, instead of inline ads, proxy can insert non-inline ads, e.g., as described above in FIG. 9. After the proxy provides the web content, the method proceeds to connector 1014 and then ends (1016).

The methods disclosed herein may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

In the preceding specification, the invention has been described with reference to specific exemplary embodiments. It will however, be evident that various modifications and changes may be made without departing from the broader spirit and scope of the invention as set forth in the claims that follow. The specification and drawings are accordingly to be regarded as illustrative rather than restrictive sense. Other embodiments of the invention may be apparent to those skilled in the art from consideration of the specification and practice of the invention disclosed herein.

What is claimed is:

1. A computer-implemented method comprising:
receiving request data originating at a mobile device;
obtaining a unique and unchanging identifier of the mobile device based on the received request data;
associating the unique and unchanging identifier of the mobile device with the request data; and
storing the associated data at a data storage device.

2. The method of claim 1, wherein the mobile device is a mobile phone.

3. The method of claim 1, wherein the unique and unchanging identifier of the mobile device is a telephone number of the mobile device.

4. The method of claim 1, wherein the unique and unchanging identifier of the mobile device is a network access identifier.

5. A computer-implemented method for providing unlimited monitoring, comprising:
receiving request data originating at a mobile device, wherein the request data corresponds to unlimited web content;
obtaining an identifier of the mobile device based on the received request data;
associating the identifier of the mobile device with the unlimited web content; and
storing the associated data at a data storage device.

6. The method of claim 5, wherein the unlimited web content includes all types of web contents.

7. The method of claim 5, wherein the mobile device is a mobile phone.

8. The method of claim 5, wherein the identifier of the mobile device is a unique and unchanging identifier of the mobile device.

9. The method of claim 5, wherein receiving the unlimited web content can occur without the use of HTTP cookies at the mobile device.

10. A computer-implemented method comprising:
receiving requested data from a mobile device, wherein the requested data includes a request for web content and characteristics of the mobile device;
receiving the web content from a content server;
configuring an off content advertisement campaign data for placing the off content advertisement campaign off the web content, wherein the off content advertisement campaign is provided based on the characteristics of the mobile device; and
transmitting the web content and the off content advertisement campaign to the mobile device.

11. The method of claim 10, wherein the off content advertisement campaign is from a local storage device, or from a remote storage device, or from a storage device hosted by a third party.

12. The method of claim 10, wherein the off content advertisement campaign is placed on a header and/or a footer off the web content.

13. The method of claim 10, further comprising:
receiving a request for an advertisement landing page from the mobile device, based on the off content advertisement campaign being selected;
providing the advertisement landing page; and
transmitting the advertisement landing page to the mobile device.

14. A computer-implemented method comprising:
receiving requested data from a mobile device, wherein the requested data includes a request for web content;
receiving the web content from a content server;
replacing an advertisement in the web content with an advertisement campaign, wherein the advertisement campaign is obtained based on user profiling data corresponding to the mobile device; and
transmitting the web content and the replaced advertisement campaign to the mobile device.

15. The method of claim 14, wherein the advertisement in the web content is a placeholder for an advertisement.

16. The method of claim 14, wherein replacing the advertisement in the web content with the advertisement campaign further comprises:
removing the advertisement in the web content; and
filling the place of the advertisement in the web content with the advertisement campaign.

17. The method of claim 14, wherein replacing the advertisement in the web content with the advertisement campaign further comprises:
removing the advertisement in the web content and the space for the advertisement in the web content;
removing markup language tags corresponding to the advertisement in the web content and markup language tags corresponding to the space for the advertisement in the web content; and
providing the advertisement campaign as an off web content advertisement campaign.

18. The method of claim 17, wherein the off content advertisement campaign is placed on a header and/or a footer off the web content.

19. A system comprising:
a mobile device capable of transmitting request data; and
a proxy configured to receive the request data, to obtain a unique and unchanging identifier of the mobile device based on the received request data, to associate the unique and unchanging identifier of the mobile device with the request data, and to store the associated data at a data storage device.

20. The system of claim 19, wherein the mobile device is a mobile phone.

21. The system of claim 19, wherein the unique and unchanging identifier of the mobile device is a telephone number of the mobile device.

22. The system of claim 19, wherein the unique and unchanging identifier of the mobile device is a network access identifier.

23. The system of claim 19, wherein the proxy obtains the unique and unchanging identifier from a gateway.

24. A system for providing unlimited monitoring, comprising:
a mobile device capable of transmitting request data, wherein the request data corresponds to unlimited web content; and
a proxy configured to receive the request data, to obtain an identifier of the mobile device based on the received request data, to associate the identifier of the mobile device with the unlimited web content, and to store the associated data at a data storage device.

25. The system of claim 24, wherein the mobile device is a mobile phone.

26. The system of claim 24, wherein the identifier of the mobile device is a unique and unchanging identifier of the mobile device.

27. The system of claim 24, wherein receiving the unlimited web content can occur without the use of HTTP cookies at the mobile device.

28. A system comprising:
a mobile device capable of transmitting request data that includes a request for web content and characteristics of the mobile device; and
a proxy configured to receive the web content from a content server, to configure an off content advertisement campaign for placing the off content advertisement campaign off the web content, and to transmit the web content and the off content advertisement campaign to the mobile device, wherein
the off content advertisement campaign is provided based on the characteristics of the mobile device.

29. The system of claim 28, wherein the proxy further comprises:
a response monitor configured to receive the web content from the content server, to obtain the off content advertisement campaign, and to transmit the web content and the off content advertisement campaign to the mobile device.

30. The system of claim 28, wherein the off content advertisement campaign is placed on a header and/or a footer off the web content.

31. The system of claim 28, wherein the proxy is further configured:
to receive request for an advertisement landing page from the mobile device, based on the off content advertisement campaign being selected;
to provide the advertisement landing page; and
to transmit the advertisement landing page to the mobile device.

32. The system of claim 28, wherein the proxy further comprises:
a request monitor configured to intercept the request data transmitted by the mobile device and to obtain advertisement parameters of the mobile device based on the characteristics of the mobile device, wherein the advertisement parameters can be used for selecting the off content advertisement campaign.

33. The system of claim 32, wherein the proxy further comprises:
an advertisement insertion module configured to receive the advertisement parameters of the mobile device, to obtain the off content advertisement campaign based on the advertisement parameters of the mobile device, and to configure the off content advertisement campaign for placing the off content advertisement campaign off the web content.

34. The system of claim 32 further comprising:
an advertisement server configured to receive the advertisement parameters, and to provide the off content advertisement campaign based on the advertisement parameters.

35. The system of claim 34, wherein the advertisement server is located in the proxy.

36. The system of claim 34, wherein the advertisement server is remote from proxy.

37. A system comprising:
a mobile device capable of transmitting request data that includes requested web content; and
a proxy configured to receive the web content from a content server, to replace an advertisement in the web content with an advertisement campaign, and to transmit the web content and the replaced advertisement campaign to the mobile device, wherein
the advertisement campaign is obtained based on user profiling data corresponding to the mobile device.

38. The system of claim 37, wherein the proxy further comprises:
a request monitor configured to intercept the request data transmitted by the mobile device and to obtain the user profiling data corresponding to the mobile device, wherein the user profiling data can be used for selecting the advertisement campaign to replace the advertisement in the web content.

39. The system of claim 37, wherein the proxy further comprises:
an advertisement insertion module configured to receive the web content, obtain the advertisement campaign based on the user profiling data corresponding to the mobile device, and to replace the advertisement in the web content with the advertisement campaign.

40. The system of claim 37, wherein the proxy further comprises:
a response monitor configured to receive the web content from the content server, to obtain the advertisement campaign for replacing the advertisement in the web content, and to transmit the web content and the replaced advertisement campaign to the mobile device.

41. The system of claim 37, wherein the advertisement in the web content is a placeholder for an advertisement.

42. The system of claim 37, wherein the proxy is further configured:
to remove the advertisement in the web content; and
to fill the place of the advertisement in the web content with the advertisement campaign.

43. The system of claim 37, wherein the proxy is further configured:
to remove the advertisement in the web content and the space for the advertisement in the web content;
to remove markup language tags corresponding to the advertisement in the web content and markup language tags corresponding to the space for the advertisement in the web content; and
to provide the advertisement campaign as an off web content advertisement campaign.

44. The system of claim 43, wherein the off content advertisement campaign is placed on a header and/or a footer off the web content.

45. The system of claim 37 further comprising:
an advertisement server configured to receive the user profiling data corresponding to the mobile device and to provide the advertisement campaign for replacing the advertisement in the web content, wherein the user profiling data is used for selecting the advertisement campaign.

46. The system of claim 45, wherein the advertisement server is located in the proxy.

47. The system of claim 45, wherein the advertisement server is remote from proxy.

48. A computer readable medium storing instructions that, when executed by a computer, cause the computer to perform a method of associating a unique and unchanging identifier of a mobile device with request data requested by the mobile device, the method comprising:
receiving the request data originating at a mobile device;
obtaining the unique and unchanging identifier of the mobile device based on the received request data;
associating the unique and unchanging identifier of the mobile device with the request data; and
storing the associated data at a data storage device.

49. A computer readable medium storing instructions that, when executed by a computer, cause the computer to perform a method for providing unlimited monitoring of request data requested by a mobile device, the method comprising:
receiving request data originating at the mobile device, wherein the request data corresponds to unlimited web content;
obtaining an identifier of the mobile device based on the received request data;
associating the identifier of the mobile device with the unlimited web content; and
storing the associated data at a data storage device.

50. A computer readable medium storing instructions that, when executed by a computer, cause the computer to perform a method of providing an off content advertisement campaign based on characteristics of a mobile device, the method comprising:
receiving requested data from the mobile device, wherein the requested data includes a request for web content and the characteristics of the mobile device;
receiving the web content from a content server;
configuring the off content advertisement campaign for placing the off content advertisement campaign off the web content, wherein the off content advertisement campaign is provided based on the characteristics of the mobile device; and
transmitting the web content and the off content advertisement campaign to the mobile device.

51. A computer readable medium storing instructions that, when executed by a computer, cause the computer to perform a method of replacing an advertisement in web content requested by a mobile device with an advertisement campaign, the method comprising:
receiving requested data from the mobile device, wherein the requested data includes a request for web content;
receiving the web content from a content server;
replacing the advertisement in the web content with the advertisement campaign, wherein the advertisement campaign is obtained based on user profiling data corresponding to the mobile device; and
transmitting the web content and the replaced advertisement campaign to the mobile device.
